(19) United States
(12) Patent Application Publication
(10) Pub. No.: US 2009/0030655 A1
(43) Pub. Date: Jan. 29, 2009

(54) Analysis Methods for unmixing the response of non-linear, cross-reactive sensors and related system to single and multiple stimulants

(76) Inventors: Gregory C. Lewin, Odense (DK); Stephen Keith Holland, Charlottesville, VA (US); Gabriel Laufer, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(21) Appl. No.: 11/886,925

(22) PCT Filed: Mar. 21, 2006
(86) PCT No.: PCT/US2006/010405

§ 371 Date: Oct. 3, 2007

Related U.S. Application Data
(60) Provisional application No. 60/663,843, filed on Mar. 21, 2005.

(51) Int. Cl. G06F 17/00

(52) U.S. Cl. 702/196

(57) ABSTRACT

Disclosed herein are methods of analysis for unmixing non-linear, cross-reactive sensors and related system. Use of the disclosed methods, related systems and computer program product permits better analysis of the magnitudes of various stimulants including but not limited to chemical concentrations. One method may add one or more additional signal vectors to the sensor response before linearizing each channel. A second method may add one or more exponential terms to the response curve when using curve parameterization to unmix the sensor response. A third method may use non-linear iterative solutions that estimates an optical depth, linearizes the optical depth, solves for a correction to the estimated optical depth, and updates the optical depth. Also, the disclosed methods and related systems include combinations of the methods described herein.

### CROSS-REFERENCE TO PRIOR APPLICATIONS

The present application claims priority under 35 U.S.C. Section 119(e) from U.S. Provisional Application No. 60/663,843, filed on Mar. 21, 2005, entitled “Analysis Methods for Unmixing Non-linear, Cross-reactive Sensors and Related System,” the disclosure of which is hereby incorporated by reference herein in its entirety.

### U.S. GOVERNMENT RIGHTS

This invention was made with United States Government support under Grant No. W91 CRB-04-C-0026, awarded by the Department of Homeland Security and the Technical Support Working Group. The United States Government has certain rights in the invention.

### FIELD OF THE INVENTION

The present invention relates to analysis of data, and more particularly, to the analysis of data from a cross-reactive, non-linear sensor. The sensor is cross-reactive because it includes multiple sensing elements, or channels, where inputs from individual stimulants affect multiple channels and where individual channels are affected by multiple stimulants. The sensor is non-linear because the output signals of some or all of its channels may vary non-linearly with the variation of the magnitude of the stimulant itself.

### BACKGROUND OF THE INVENTION

A sensor of any physical, chemicals, or biological stimulant may be composed of several channels that are sensitive to one or more stimulants. An example of such a sensor is a radiometer consisting of multiple detector elements that measure simultaneously the absorption of infrared (IR) radiation by chemicals. Such sensors can be combined to make up a system which would be cross-reactive, in that absorption by individual chemicals affect multiple channels, and individual channels are affected by absorption by multiple chemicals. A cross-reactive response can be experienced also by sensors that include only one radiation sensing element but where the spectrum is scanned or resolved by additional means such as a prism or diffraction grating. In addition, the output signal of the sensor may vary non-linearly with the magnitude of the stimulant. An example for such non-linear response is the exponential variation, as described by Beer's law, of the absorption of radiation with the number of absorbing chemical molecules along the path of the absorbed radiation. As the concentration of the chemicals, C, or the absorption path length, l, increase, the extent of the transmitted radiation decreases as exp(−αCl) where α is an absorption coefficient (itself a function of wavelength) that is characteristic of the chemical that absorbs that radiation. Other sensors, such as the electronic nose (EN) that is manufactured by Smiths Detection, where multiple detectors sample the air and provide information on its chemical make up, have cross-reactive and non-linear response characteristics although their principle of operation does not depend on the absorption of IR radiation.

These outputs of the multiple elements of such sensors must be unmixed, wherein the identity and magnitude of the one or more stimulants that created the signals are determined by a mathematical or numerical analysis of said signals. The magnitude may be the optical depth (the product of C and l when the detection is optical), or concentration C (when the detection is by a sampling sensor) of each of the chemical(s) sampled or otherwise detected by the sensor. The magnitudes are determined by processing the combined outputs of the multiple channels of the sensor. Often, such unmixing analysis involves the comparison of the outputs of the multiple channels with a library of known signatures or spectra for the stimulants, e.g., chemical(s), of interest. The potentially wide range of magnitudes of stimulants, or concentration of chemicals, significantly complicates the data reduction process because the non-linear relationship between the response of each of the elements of this sensor thereby precluding the use of linear unmixing techniques.

Data analysis methods for unmixing non-linear outputs of cross-reactive sensor systems, including chemical detection systems, include, but are not limited thereto, the following: enhanced linear techniques, parameterization (curve fitting), non-linear iterative solutions, and combinations thereof.

Linear unmixing techniques all share a common approach: detector responses are projected onto a library of known chemical signatures using linear techniques such as linear least squares projection, orthogonal subspace projection, or principal components analysis. A given sensor response is ummixed by projection of the response onto all of the signatures available in the library, or subset thereof.

One drawback of linear techniques is the increasing divergence between the estimated magnitude of the stimulant and its actual magnitude due to the difficulties posed by the non-linearity of the problem. This may be apparent as disagreement between the measured signal and its departure from the corresponding signature in the stored library that may prevent correct identification of that stimulant. This departure is caused by the ever-increasing non-linear response of the channels that are highly sensitive to the stimulant while the response in the channels with low sensitivity to the stimulant can remain close to linear. Yet another drawback is that the signal in channels that are sensitive to inputs of more than one stimulant may vary non-linearly with the magnitudes of those individual stimulants when more than one is present, thereby corrupting their individual signature or even obscuring the presence of one or more of the participating stimulants.

When the magnitude of the stimulant is low, the response at each of the sensor channels is nearly linear and the results from use of linear techniques closely follow the actual variation in the magnitude of the stimulant. However, as the magnitude of the stimulant (e.g., optical depth or concentration of chemicals) increases, the outputs from some or all the channels of the sensor deviate significantly from a linear dependence on the actual magnitude of the stimulant. Significant error may be induced when the magnitude of the stimulant is particularly high. At that point further increase in the magnitude of the stimulant may lead to small or no change in the magnitude of the outputs of some or all of the channels. Such restricted response is known in the art as saturation. Saturated response may lead to the erroneous conclusion that the magnitude of the stimulant is higher or lower than its actual magnitude or to a wrongly recorded signature that may lead to an erroneous identification of one or more stimulants. If such a sensor is used to provide an alarm, such erroneous identification or quantification of the magnitude may lead to false positive alarm (i.e., sounding an alarm when a threat does not exist) or false negative alarm (i.e., not sounding an alarm when a threat actually exists).

All linear techniques suffer from the same limitations when used to analyze non-linear processes although their implementations differ in their details. Furthermore, the linear algebraic techniques known as orthogonal subspace projection and principal components analysis can be shown to be analogous to linear least squares projection and will not be considered as separate methods.

An alternative approach to linearly unmixing the sensor response is to parameterize (curve fitting) the response of each channel as a function of the actual magnitude of the stimulant. In this approach, sets of equations are developed to represent the response of each channel to the various stimulants. The equations included coefficients whose values are determined through a calibration process where known stimulants at known quantities are presented to the system. Then the actual magnitude can be determined from the measured response by “inverting” the parameterized curves. Higher-order methods for parameterizing the response curves can be developed, along with methods for inverting the resulting system of equations.

A drawback to parameterization is that it does not take into account the differing sensitivities of individual channels to finer or secondary response structures of the stimulant. To illustrate, if an individual channel measures the absorption of radiation by a given chemical within a pre-set spectral range, if the absorption structure of that chemical includes finer spectral lines with various absorption coefficients, the lines that correspond to a large absorption coefficient can register much more strongly than the lines with the smaller absorption coefficient. Therefore, at low optical depths, the response will be dominated by the strong absorption lines. As the optical depth increases, however, the strong lines will saturate first, and the differential response due to further increases in optical depth will be dependent on progressively weaker absorption lines.

Another drawback of the parameterization approach is the need for very large and complex signature library. The reason is that while the system response to ten stimulants, e.g., chemicals, can be parameterized by ten equations, the response to pairs of stimulants may require a set of 45 equations that parameterize the interactions (the number of different pairs being 10×9/2). For increasing numbers of chemicals in combination (three, four, etc.), the number of equations needed to parameterize the system grows even faster.

Yet another approach to unmixing sensor response is to use a non-linear iterative technique for determining the magnitudes of the stimulant. The method uses a localized linear projection to refine subsequent estimates of the magnitude. The simulated response due to each estimate is compared to the actual detector response, and discrepancies are used to update the estimated chemical composition.

One drawback to the non-linear iterative technique is that it is a computationally intensive method.

Some of the methods described above can provide more accurate estimates of the true composition of the stimulants being sampled but may take longer to process. Thus, it can be beneficial to use combinations of methods to determine the composition. For example, it is possible to obtain an initial estimate of one or more stimulants by using a linear technique, but then repeat the analysis using a second analytical or numerical method such as curve parameterization or non-linear iterative solution to obtain confirmation or precise determination of the magnitude of the identified stimulants. The drawback of this approach is that it still may lead to missed identification of the stimulants being sensed by the sensor and consequently the estimate of the magnitude (e.g., optical depth or concentration) will be in error.

Data analysis methods and systems for, among other things, unmixing the outputs of non-linear, cross-reactive sensors, including but not limited to those produced by radiometers, spectroscopic systems that include prisms or gratings, sampling sensors described above, and radioactivity sensors, may be applicable to many detection systems. Note that when using a sampling sensor, such as the electronic nose, the optical depth term would be replaced with the concentration.

Therefore there is need in the art for an effective analysis method to provide better unmixing of non-linear, cross-reactive sensors. Particular needs remain for better analysis by use of enhanced linear techniques, curve parameterization, non-linear iterative solutions, and combinations thereof.

### SUMMARY OF INVENTION

A method to unmix the outputs of non-linear, cross-reactive sensors and related systems is disclosed. An aspect of various embodiments of the present invention may use a combination of one or more different mathematical and numerical techniques to achieve an estimate of the magnitudes, more accurately than with linear techniques, of one or more stimulants that are being detected and/or measured by the sensor.

With regards to an aspect, various embodiments of the present invention provide methods of analyzing data produced by a plurality of cross-reactive channels that respond non-linearly to the magnitude of one or more stimulants, to differentiate between these stimulants, identify them, and determine their magnitudes, wherein each method comprises: obtaining signals from each of a plurality of channels within said sensor; producing a net normalized response from each signal, and comparing the net normalized response to a predetermined library of chemical signatures. The differences shall lie in the nature of the signature library and the method used to unmix the responses.

Unmixing is the process by which the presence and magnitude of one or more stimulants or chemicals are determined from the sensor response.

The net normalized response is a signal that is processed by a predetermined mathematical formula to correct for variations in reference conditions (e.g., background variations), and phenomena that affect signal amplitude such as channel gain or detector response.

A signature library is a database of information pertaining to the response of a stimulant at known quantities. A signature library may be built by sampling a known quantity or quantities of target stimulants and recording the response of the sensor. Alternatively, the library may consist of parameterized equations of the response of the system to target stimulants. Alternatively, the library may consist of fundamental physical information that may be used to predict the response of the sensor to target stimulants. In each case, however, the library represents, or is used to determine, the response of the system to known quantities of target stimulants with varying degrees of accuracy.

In one aspect, an embodiment of the present invention presents a method of unmixing whereby a library of signatures is created and maintained for a number of stimulants at a predetermined number of magnitudes. The signature of a stimulant at each magnitude may be different from the signature at one or more other magnitudes of the same stimulant and is treated as if it is represented by a separate stimulant. The net normalized response is compared to the signatures of every stimulant in the library, or a subset thereof, at each magnitude using a prescribed technique such as linear least squares projection, a mathematical technique that simultaneously finds the proportion of the response that corresponds to each of the signatures in the library or library subset.

In a second aspect, an embodiment of the present invention presents a method of unmixing whereby the signatures of each channel is parameterized with respect to the magnitude of stimulant used to generate the signatures. That is, a mathematical equation is developed that describes the response of each channel (the dependent variables) with respect to the magnitude of stimulant (the independent variable) either by an experimental or theoretical analysis. The parameterization may consist of a simple exponential term; alternatively, additional terms can be incorporated to produce a more accurate parameterization in that it more closely represents the signatures of a stimulant over a wide range of magnitudes.

In a third aspect, an embodiment of the present invention provides a method of unmixing whereby a non-linear iterative method is used to determine the presence and magnitude of stimulants. With this method, the estimated magnitude of stimulant(s) is improved through repeated application of a linear technique such as linear least squares projection. For each iteration, the estimated magnitude(s) is improved by comparing the actual response to the response predicted from the signature library, where the signature library contains sufficient information to predict the response of the sensor at the current estimated magnitude(s) of stimulant(s). The difference between the two is projected (using linear least squares or other suitable projection technique) onto the marginal response of the system as predicted by the signature library at the currently estimated magnitude(s) of each stimulant. With each iteration, the estimated magnitude(s) is improved and updated until suitable accuracy is achieved.

In a fourth aspect, an embodiment of the present invention provides a method for analyzing data produced by a plurality of cross-reactive channels responding to a non-linearly varying signal generated by one or more stimulants to differentiate between those stimulants, identify them, and determine their magnitudes, wherein the said method comprises of a combination of the aforementioned methods.

An aspect of various embodiments of the present invention provides a method for analyzing signals from a plurality of cross reactive channels of a sensor of a system, wherein the signals vary non-linearly with the quantities of stimulant that induce these signals. The method comprises: obtaining signals from a plurality of channels from the sensor at a variety of known levels for each stimulant; producing a net normalized result from each signal from the known levels; creating a library of signatures that includes the net normalized result at each of the known levels of stimulant; obtaining one or more signals from a plurality of channels from the sensor at unknown levels of stimulant; producing a net normalized result from each signal from the unknown levels; and unmixing the net normalized result from the unknown levels by projecting the sensor response onto the library of known signatures, with the various levels of each stimulant being treated as independent stimulants.

An aspect of various embodiments of the present invention provides a method for analyzing signals from a plurality of cross reactive channels of a sensor of a system, wherein the signals vary non-linearly with the quantity of stimulants that induce these signals. The method comprises: obtaining signals from a plurality of channels from the sensor at a variety of known levels for each stimulant; producing a net normalized result from each signal from the known levels; creating a library of signatures by developing a parameterized equation that matches the net normalized result at each of the known levels of each stimulant in terms of the level of stimulant; obtaining one or more signals from a plurality of channels from the sensor at unknown levels of stimulants; producing a net normalized result from each signal from the unknown levels; and unmixing the net normalized result from the unknown levels by comparing it to the library of parameterized signatures.

An aspect of various embodiments of the present invention provides a method for analyzing signals from a plurality of cross reactive channels of a sensor of a system, wherein the signals vary non-linearly with the magnitude of stimulants that induce these signals. The method comprises: obtaining signals from a plurality of channels from said sensor; producing a net normalized result from each signal; estimating initially the magnitude or magnitudes of stimulant(s); predicting a net normalized result from a model of the physics of the system by using said estimated magnitude or magnitudes of stimulant(s); determining the difference between the actual net normalized result and the predicted net normalized result; using said difference to solve for a correction to the estimated magnitude(s); updating the magnitude or magnitudes of stimulant(s); and repeating the prediction, determination of the difference, determination of the correction, and updating the magnitude(s).

An aspect of various embodiments of the present invention provides a system for analyzing for analyzing signals from a plurality of cross reactive channels of a sensor of the system, wherein the signals vary non-linearly with the quantities of stimulant that induce these signals. The system comprises at least one data processor, module, hardware/apparatus or any available means, as well as any combination thereof, designed or adapted to: obtain signals from a plurality of channels from the sensor at a variety of known levels for each stimulant; produce a net normalized result from each signal from the known levels; create a library of signatures that includes the net normalized result at each of the known levels of stimulant; obtain one or more signals from a plurality of channels from the sensor at unknown levels of stimulant; produce a net normalized result from each signal from the unknown levels; and unmix the net normalized result from the unknown levels by projecting the sensor response onto the library of known signatures, with the various levels of each stimulant being treated as independent stimulants.

An aspect of various embodiments of the present invention provides a system for analyzing signals from a plurality of cross reactive channels of a sensor of the system, wherein the signals vary non-linearly with the quantity of stimulants that induce these signals. The system comprises at least one data processor, module, hardware/apparatus or any available means, as well as any combination thereof, designed or adapted to: obtain signals from a plurality of channels from said sensor at a variety of known levels for each stimulant; produce a net normalized result from each signal from the known levels; create a library of signatures by developing a parameterized equation that matches the net normalized result at each of the known levels of each stimulant in terms of the level of stimulant; obtain one or more signals from a plurality of channels from said sensor at unknown levels of stimulants; produce a net normalized result from each signal from the unknown levels; and unmix the net normalized result from the unknown levels by comparing it to the library of parameterized signatures.

An aspect of various embodiments of the present invention provides a system for analyzing signals from a plurality of cross reactive channels of a sensor of the system, wherein the signals vary non-linearly with the magnitude of stimulants that induce these signals. The system comprises at least one data processor data processor, module, hardware/apparatus or any available means, as well as any combination thereof, designed or adapted to: obtain signals from a plurality of channels from the sensor; produce a net normalized result from each signal; estimate initially the magnitude or magnitudes of stimulant(s); predict a net normalized result from a model of the physics of the system by using the estimated magnitude or magnitudes of stimulant(s); determine the difference between the actual net normalized result and the predicted net normalized result; use the difference to solve for a correction to the estimated magnitude(s); update the magnitude or magnitudes of stimulant(s); and repeat the prediction, determination of the difference, determination of the correction, and updating the magnitude(s).

An aspect of various embodiments of the present invention provides a computer program product comprising a computer useable medium having computer program logic for enabling one processor in a computer system to analyze signals from a plurality of cross reactive channels of a sensor of a system, wherein the signals vary non-linearly with the quantities of stimulant that induce these signals. The computer program logic comprises: obtaining signals from a plurality of channels from the sensor at a variety of known levels for each stimulant; producing a net normalized result from each signal from the known levels; creating a library of signatures that includes the net normalized result at each of the known levels of stimulant; obtaining one or more signals from a plurality of channels from the sensor at unknown levels of stimulant; producing a net normalized result from each signal from the unknown levels; and unmixing the net normalized result from the unknown levels by projecting the sensor response onto the library of known signatures, with the various levels of each stimulant being treated as independent stimulants.

An aspect of various embodiments of the present invention provides a computer program product comprising a computer useable medium having computer program logic for enabling one processor in a computer system to analyze signals from a plurality of cross reactive channels of a sensor of a system, wherein the signals vary non-linearly with the quantity of stimulants that induce these signals. The computer program logic comprises: obtaining signals from a plurality of channels from the sensor at a variety of known levels for each stimulant; producing a net normalized result from each signal from the known levels; creating a library of signatures by developing a parameterized equation that matches the net normalized result at each of the known levels of each stimulant in terms of the level of stimulant; obtaining one or more signals from a plurality of channels from the sensor at unknown levels of stimulants; producing a net normalized result from each signal from the unknown levels; and unmixing the net normalized result from the unknown levels by comparing it to the library of parameterized signatures.

An aspect of various embodiments of the present invention provides a computer program product comprising a computer useable medium having computer program logic for enabling one processor in a computer system to analyze signals from a plurality of cross reactive channels of a sensor of a system, wherein the signals vary non-linearly with the magnitude of stimulants that induce these signals. The computer program logic comprises: obtaining signals from a plurality of channels from the sensor; producing a net normalized result from each signal; estimating initially the magnitude or magnitudes of stimulant(s); predicting a net normalized result from a model of the physics of the system by using the estimated magnitude or magnitudes of stimulant(s); determining the difference between the actual net normalized result and the predicted net normalized result; using the difference to solve for a correction to the estimated magnitude(s); updating the magnitude or magnitudes of stimulant(s); and repeating the prediction, determination of the difference, determination of the correction, and updating the magnitude(s).

In short, various aspects of embodiments of the invention provide the art with heretofore unappreciated methods for analyzing data to differentiate non-linear, cross-reactive signals from a plurality of detectors.

These and other objects, along with advantages and features of the invention disclosed herein, will be made more apparent from the description, drawings, and claims that follow.

### BRIEF DESCRIPTIONS OF THE DRAWINGS

The foregoing and other objects, features, and advantages of the present invention, as well as the invention itself, will be more fully understood from the following description of preferred embodiments, when read together with the accompanying drawings, in which:

FIG. 1 schematically represents an exemplary detection system that may be implemented in whole or in part with analysis methods, systems and computer program product of the various aspects and embodiments of the present invention.

FIG. 2 graphically shows a comparison during an artificial numerical test between the estimated and actual optical depths of ethylene oxide and vinyl chloride, obtained by using linear least squares projection. The exact optical depth of EO was varied from 10⁻⁶ to 10³ atm-cm while the exact optical depth of VC was zero. The simulated response vector was projected onto the signatures for the two target chemicals. The straight line represents the exact optical depth of EO.

FIG. 3 graphically shows a comparison during an artificial numerical test between the estimated and actual optical depths of ethylene oxide and vinyl chloride, obtained by using linear least squares projection, with signatures created at multiple optical depths. The dashed line shows the error introduced by this algorithm. The exact optical depth of EO was varied from 10⁻⁶ to 10³ atm-cm while the optical depth of VC was zero. The simulated response vector was projected onto three signatures each of target chemicals created at optical depths of 3.81×10⁻³, 1.22×10⁻¹, and 3.91 atm-cm. The additional curve (dashed line) shows the error (d) between the exact response vector and the response vector of the estimated composition.

FIG. 4 graphically shows a comparison during an artificial numerical test between the estimated optical and actual depths of ethylene oxide and vinyl chloride, using curve parameterization. The dashed line shows the error introduced by this algorithm. The exact optical depth of EO was varied from 10⁻⁶ to 10³ atm-cm while the exact optical depth of VC was kept zero. The estimated optical depth was found using Equation (11). The additional curve (dashed line) shows the error (d) between the exact response vector and the response vector of the estimated composition.

FIG. 5 graphically shows the variation during an artificial numerical test of the exact and parameterized net normalized response of a single channel over a range of optical depths of ethylene oxide. The actual (exact) curve is determined by numerically integrating Equation (2). The simple exponential curve is calculated from Equation (7) and the higher-order approximation from Equation (12).

FIG. 6 graphically shows a comparison during an artificial numerical test between the estimated and the actual optical depths of ethylene oxide and vinyl chloride using higher-order curve parameterization. The dashed line shows the error introduced by this algorithm. The exact optical depth of EO was varied from 10⁻⁶ to 10³ atm-cm and the estimated optical depth was found by solving Equation (12) for each channel and averaging the optical depths. The additional curve (dashed lines) shows the error (d) between the exact response vector and the response vector of the estimated composition.

FIG. 7 graphically shows a comparison during an artificial numerical test between the estimated and the actual optical depths of ethylene oxide and vinyl chloride using non-linear iteration. The exact optical depth of EO was varied from 10⁻⁶ to 10³ atm-cm. The estimated optical depth matches the exact optical depth perfectly.

FIG. 8 represents a functional block diagram for a computer system for implementation of various aspects and embodiments of the present invention.

### DETAILED DESCRIPTION OF THE INVENTION

A low-cost, multi-spectral, remote chemical sensor for detection of toxic industrial chemicals in fixed-location applications (e.g., for chemical detection in building HVAC systems) and for vehicle and handheld applications (e.g., for deployment on unmanned air vehicle) was developed. The infrared sensor is composed of 16 channels, each consisting of uncooled pyroelectric detectors fitted with infrared bandpass filters, providing sensitivity to chemical absorption features in the 3-5 μm and 8-12 μm spectral ranges. The system is cross-reactive, in that individual chemicals affect multiple channels, and individual channels are affected by multiple chemicals. Although the infrared cross-reactive sensor is used as the primary example in this description, the methods will apply to many cross-reactive systems.

The outputs of the 16 detector channels of the sensor can be subtracted from a reference signal and normalized to yield a bar-chart that can be viewed as a coarse spectrum of the chemical(s) in the field of view (FOV). This spectrum must be unmixed, wherein the identity and optical depth of the chemical(s) in the FOV are estimated by processing the spectrum and comparing the results with a library of known signatures for the chemical(s) of interest.

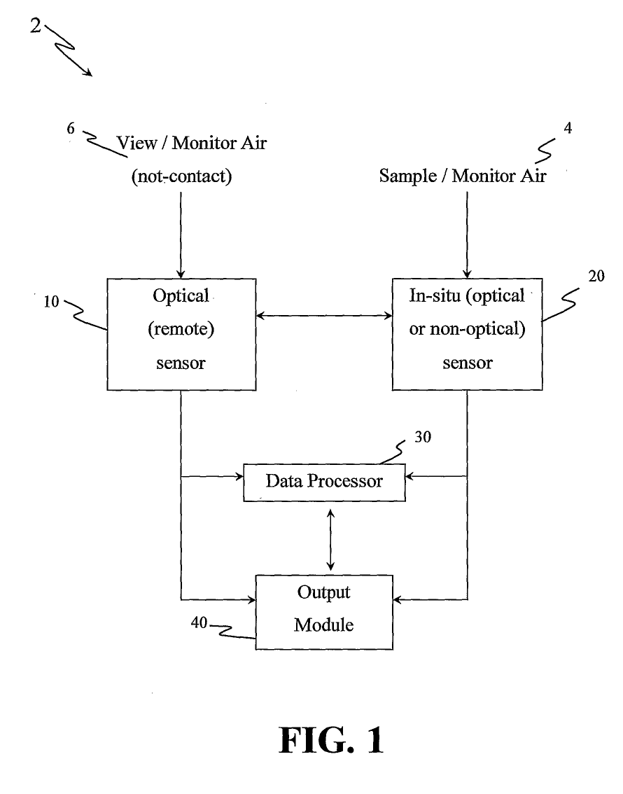

An example of a chemical detection system is illustrated in FIG. 1 and disclosed in International Application No. PCT/US2005/037030, filed Oct. 14, 2005, entitled “Remote Sensor and In-situ Sensor for Improved Detection of Chemicals in the Atmosphere and Related Method thereof,” of which is assigned to the present assignee and is hereby incorporated by reference herein in its entirety. Other systems and methods as discussed or cited in Application No. PCT/US2005/037030 may be implemented in whole or in part with analysis methods, systems and computer program product of the various aspects and embodiments of the present invention. FIG. 1 represents an exemplary detection system that may be implemented in whole in or part with analysis methods, systems and computer program product of the various embodiments of the present invention discussed herein. Turning to FIG. 1, FIG. 1 illustrates schematic block diagram of an aspect of an embodiment of a detection system 2 that may comprise at least one remote sensor 10 that may be in communication with at least one in-situ sensor 20 wherein at least one data processor 30 is adapted for analyzing output or data received from the remote sensor 10 and in-situ sensor 20 for detection in a given atmosphere, which may include surrounding area, vicinity, volume, container, enclosure, duct, dwelling, vehicle, or environment. Any of the aforementioned components of the detection system may be in communication with an output module 40 that may be any one of a variety of devices or systems such as but not limited thereto the following: alarm, memory, data storage device such as a computer hard drive, computer network, television screen or monitor, printer, recording device, communication device, telephone, computer, another processor, or recorder or any combination thereof. The in-situ sensor 20 may detect chemicals in the air or atmosphere by sampling air 4 in their immediate vicinity and analyzing it. The in-situ sensors 20 must be in physical contact with the detected chemical and cannot make any judgment regarding the makeup of air at other locations with which they do not have physical contact. The in-situ sensor 20 may be an optical sensor or a non-optical sensor. Still referring to FIG. 1, the remote sensors 10 and certain optical sensors can detect chemicals remotely, i.e., at locations away from the sensor and without physical contact with the target chemical. The remote sensors 10 can detect analytes without contacting the air and by viewing air 6 or radiation that passed through the air from a natural or man made source. Although, it should be appreciated that remote sensors are not precluded from being in physical contact with the target chemical. Remote sensors can identify chemicals, and often determine their concentration, even while being outside the cloud formed by those chemicals. The remote sensor 10 may include certain optical sensors. Remote is defined as standoff or non-contact.

Next, it should be appreciated that the communication of data and information transferred among the modules and components (e.g., in-situ sensor 20, remote sensor 10, data processor 30, output module 40, etc.) of the Chemical detection/monitoring system 2 discussed throughout this document may be implemented using software and data transferred via communications interfaces that are in the form of signals, which may be electronic, electromagnetic, optical, RF, wireless, infrared or other signals capable of being received by communications interfaces. The signals may be provided via communications paths or channels (or any other communication means or channel disclosed herein or commercially available) that carries signals and may be implemented using wire or cable, fiber optics, integrated circuitry, a phone line, a cellular phone link, an RF link, an infrared link, wireless communication and other communications channels/means commercially available.

Other examples of the output module 40 may include a computer user interface/graphic user interface that may include various devices such as, but not limited thereto, input devices, mouse devices, keyboards, monitors, printers or other computers and processors. The computer/graphic user interface may be local or long distance to the detection system 2. It should be appreciated that there may be one or more computer user interface/graphic user interface that may be in communication with any of the components, modules, instruments, devices, vehicles, systems and equipment discussed herein. For example, the computer user interface/graphic user interface may be located locally or long distance. Such a remote communication of the computer user interface/graphic user interface may be accomplished a number of way including an uplink/communication path to a cell telephone network (e.g., external device/system) or satellite (e.g., external device/system) to exchange data with a central processing point (e.g., external device/system).

The detection/monitoring system 2 may also be in communication with an external device(s) or system(s) such as at least one of the following transmitters, receivers, controllers/processors, computers, satellites, telephone cell network, PDA's, workstations, and other devices/systems/instruments/equipment/sensors. The aforementioned external device/systems may be comprised of one or plurality and may be locally and/or long-distance located.

Further, the detection/monitoring system 2 may also comprise or be in communication with an auxiliary system/device/instrument/sensor, as well as a plurality of such systems/devices/instruments. Such auxiliary system/device/instrument/sensor may include, but not limited thereto, the following: communication device/system, robot, global positioning system (GPS), positioning device/system, vehicles, or any other device/system/instrument/sensor as desired or required. The aforementioned auxiliary device/system/instrument/sensor may be comprise of one or plurality and may be locally and/or long-distance located.

Still yet, examples of the data processor 30 may be a variety of processors or controllers implemented using hardware, software or a combination thereof and may be implemented in one or more computer systems or other processing systems, such as general purpose computer or personal digital assistants (PDAs). Further, the data processor 30 as discussed throughout may be a single processor or multiple processors for a given sensor/monitor system 2.

Further yet, it should be appreciated that any of the modules and components (e.g, in-situ sensor 20, remote sensor 10, data processor 30, output module 40) for a given sensor/monitoring system 2 may be all integrated together in one housing or may be separate components or any combination there of whereby some of the modules and components are integrated together and some are not.

Examples of in-situ sensors may include, but not limited thereto, the following: in-surface acoustic wave (SAW), micro-cantilever (MC), ELECTRONIC NOSE (EN) type sensor, chemi-resitor type sensor, gas chromatograph type sensor, interferometric type waveguide sensor, chemical paper type sensor, TOTALLY OPTICAL VAPOR ANALYZER (TOVA™) type sensor, a differential absorption type sensor, a Fourier transform type spectrometer or radiometer, a tunable etalon type sensor, a grating based spectrometer type sensor, a lidar type sensor, a differential absorption lidar (DIAL) type sensor, or Ion Mobility Spectrometer (IMS), or the like.

Typically remote sensors depend on optical techniques and use certain optical characteristics of the target chemicals for detection. For the purpose of this application, optical techniques are defined as all the techniques that depend on electromagnetic radiation for detection irrespective of the radiation frequency (or wavelength), including but not limited to x-ray, ultraviolet, visible, infrared, microwave and radio frequency radiation. The source of light used with a remote sensor may be natural, man-made or other—the source of light is not considered part of the remote sensor for the purposes of this application. Thus in one application, it is possible to have a radiation source at one location pointing towards the optical sensor at another location and the detection is made of chemicals that are located along the radiation path (line-of-sight) between the radiation source and the optical sensor. For detection, the chemical cloud may fill the entire space between the source and the sensor or may fill only portion of that space.

Optical thickness is defined as αᵢCᵢl, where αᵢ(λ) is the wavelength-dependent absorptivity of a given chemical or of a set of chemicals for which response has been modeled (the index i indicates that this is the i^{th} chemical of the set), Cᵢ is its concentration of the i^{th} chemical, λ is the wavelength, and l is the path length. Optical depth is defined as Cᵢl. When the optical thickness is small (αᵢCᵢl<<1), the bar-chart spectrum may be unmixed using linear techniques (e.g., linear least squares projection) to identify the chemicals in the field of view (FOV). However, the potentially wide range of optical depths of target chemicals and interferents significantly complicates the data reduction process. Using an early prototype of the system, linear techniques were shown to be suitable for identifying chemicals at low optical depths, as discussed in S. K. Holland's “Low-cost Remote Chemical Sensing.” However, in many applications, the absorption path length in the FOV will be long, potentially yielding a relatively large optical depth even in the presence of low concentrations or even low absortivity.

A goal of various embodiments of the present invention is to provide a variety of data analysis methods designed to reduce data from various cross-reactive sensors such as the infrared, cross-reactive, optical sensor described above, but the invention will also be applicable to the processing of data obtained from any sensor consisting of multiple cross-reactive channels whose outputs vary non-linearly with the magnitude of the stimulant, or quantity being sensed. Examples include the electronic nose (EN) that is produced by Smiths Detection, a cantilever type sensor that is developed by Graviton, or a surface acoustic wave (SAW) type sensor that is produced by Microsensor Systems, Inc.

In the following explanation, after describing the system response model, we develop an objective measure for the performance of a particular data analysis method. First, the shortcomings of linear projection methods are demonstrated, and then several methods for improving the data analysis are presented: enhancements to linear projection methods; parameterization (curve fitting) of the system response; and non-linear, iterative techniques. Finally, the relevance of the methods to the problem at hand will be discussed, with an emphasis on both accuracy and complexity.

### System Model

In the system model, e.g., the infrared cross-reactive sensor, self-emission of the filters and other internal sensor components can be ignored without loss of generality since they will be factored out when the signal is reference corrected. Reference correcting of the signal will be discussed below. Therefore, as contended by S. K. Holland, the signal, s, for a given channel with filter with transmission, τ(λ), is given by:

$$s = \int [ {ɛ}_{s} {W}_{s} ( λ ) {e}^{- {\sum }_{i} {α}_{i} ( λ ) {C}_{i} l} + ( 1 - {e}^{- {\sum }_{i} {α}_{i} ( λ ) {C}_{i} l} ) {W}_{v} ( λ ) ] {τ}_{j} ( λ ) d λ . \qquad ( 1 )$$

The variables Wₛ and Wᵥ represent the directional spectral radiant emission from the heat (or radiative) source and gas, respectively, and are defined by the Planck function at their respective temperatures. The variable εₛ is the spectral emissivity of the source. While subject to future modification, the initial design (and what is assumed for the examples presented) is for a path length of 10 m and a hot blackbody source at temperature of 400 K in the FOV. Signals are taken continuously and can be reference corrected by first subtracting them from a reference signal for that channel (the signal when no chemicals are present), s(0). The result can then be divided by s(0) to produce the net normalized response (NNR) of a given channel, represented by r:

$$r = \frac{s ( 0 ) - s}{s ( 0 )} = \frac{\int [ ( ɛ {W}_{s} - {W}_{v} ) ( 1 - {e}^{- {\sum }_{i} {α}_{i} ( λ ) {C}_{i} l} ) ] {τ}_{f} ( λ ) d λ}{\int [ {ɛ}_{s} {W}_{s} ( λ ) ] {τ}_{f} ( λ ) d λ} . \qquad ( 2 )$$

It is important to note that the NNR is integrated over exponential terms with wavelength-dependent coefficients. That is, the absorptivity is a function of wavelength and it is therefore expected that variations in the absorption spectra will contribute differently to the NNR. This will have important consequences for the unmixing methods considered below.

For each channel the NNR is obtained either experimentally by measuring s and s(0) or by integrating Equation 2 over a spectral range defined by the bandpass filters of that channel. The set of NNRs from several channels is a vector (with 16 components in the embodiment being discussed), and the net normalized response vector (or simply response vector) of a particular chemical at one or more predetermined concentrations will be called its signature. Thus, a library of chemical signatures can be created and used to unmix response vectors to estimate what chemicals are present in the field of view.

### Comparing Data Analysis Methods

A simple means of measuring the accuracy of a data analysis method is to simulate (i.e., generate artificially) a response vector to a known chemical (or mixture of chemicals), unmix it using a library of known chemical signatures, and compare the composition of the mixture used to simulate the response vector with the estimated (unmixed) composition. Throughout this description, unmixing methods will be tested by simulating a response vector due to ethylene oxide (EO), a common toxic industrial chemical (TIC) and unmixing it using a chemical library consisting of either EO alone or EO and vinyl chloride (VC). Then the optical depth of EO used to simulate the response vector can be compared to its estimated optical depth. Any deviation between the two is an indication of errors in the unmixing procedure. Also, when two library chemicals are used, if the estimate for VC is non-zero, although only EO was assumed to be present, it would indicate errors. In many applications, the library may contain more chemicals but using two chemicals for this illustration is sufficient to demonstrate the shortcomings of some approaches and the advantages of others. In many applications, the library may contain more chemicals but using two chemicals for this illustration is sufficient to demonstrate the shortcomings of some approaches and the advantages of others.

However, comparing the exact (or simulated) and estimated optical depths will not show any errors that are “orthogonal” to the chemical signature(s) in the library. A complimentary measure is to simulate a response vector to an unmixed chemical composition and determine if it is consistent with the response vector that was obtained by the original unmixing. In our examples, the comparison consists of the following steps:
Simulate a noise-free response vector for EO at a known optical depth. The noise-free response vector will be referred to as the “exact” composition and “exact” response, since it is stipulated at the beginning of the trial;
Using the data analysis method of interest, unmix the response vector to estimate the optical depth of the library chemical(s);
Using these estimated optical depths, simulate the noise-free response vector of the sensor. This will be referred to as the “estimated” response vector since it is a result of simulating the response to the estimated optical depths; and
Compare the exact response vector with the estimated response vector by calculating the “distance” between the two in the response vector space.

This procedure can be repeated for a range of optical depths (i.e., by varying the exact optical depth of EO).

The responses can be compared objectively by calculating the Mahalanobis distance between each two response vectors, i.e., between the simulated and estimated response curves of each stimulant. Given a noise covariance matrix S, the Mahalanobis distance, dₛₜᵢₘᵤₗₐₙₜ, is given by:

dₛₜᵢₘᵤₗₐₙₜ²=(r−\hat{r})′S⁻¹(r−\hat{r}) (3),

wherein r is the exact response vector for a given stimulant and \hat{r} is the estimated response vector for that same stimulant. The better the agreement between the two, the lower dₛₜᵢₘᵤₗₐₙₜ will be (n.b., dₛₜᵢₘᵤₗₐₙₜ is a dimensionless quantity since in its calculation the error has been normalized by the noise covariance matrix and therefore represents the distance between the two vectors relative to a noise related scatter parameter). For the purposes of this description, it is arbitrarily assumed that system can provide an uncorrelated signal-to-noise ratio of 500:1.

### Problems With Linear Unmixing

The difficulties posed by the non-linearity of the problem can be demonstrated by a simple example. The exact response of the sensor to EO was simulated over a range of optical depths. The response vectors were unmixed by projecting them (using linear least squares projection) onto the signatures of two chemicals (EO and VC), which were created using optically thin clouds for each chemical (α(λ)ᵢCᵢl<<1).

Linearizing Equation (2) for each channel produces a NNR of the form:

$${r}_{j} \approx {\sum }_{i} {a}_{ij} {x}_{i} , \qquad ( 4 )$$

where rⱼ is the NNR of channel j and xᵢ is a convenient short hand for the optical depth of chemical i, (in other applications it may be the concentration of chemical i or the magnitude of the i^{th} stimulant). The coefficients aᵢⱼ represent the contribution of the absorptivity of chemical i to the NNR of channel j (i.e., aᵢⱼ is the j^{th} component of the i^{th} chemical signature). Using M as the matrix of the coefficients aᵢⱼ, the response vector in the presence of one or more chemicals can be written:

r≈Mx (5),

where x is the vector made up of the xᵢ quantities and the optical depths of the participating chemicals are found using the standard formula for least squares projection:

x=(M′S⁻¹M)⁻¹M′S⁻¹r (6).

Where M′ is the transpose of the matrix M and S is the noise covariance matrix of the system. In some applications, the matrix S can be omitted or replace by the identity matrix.

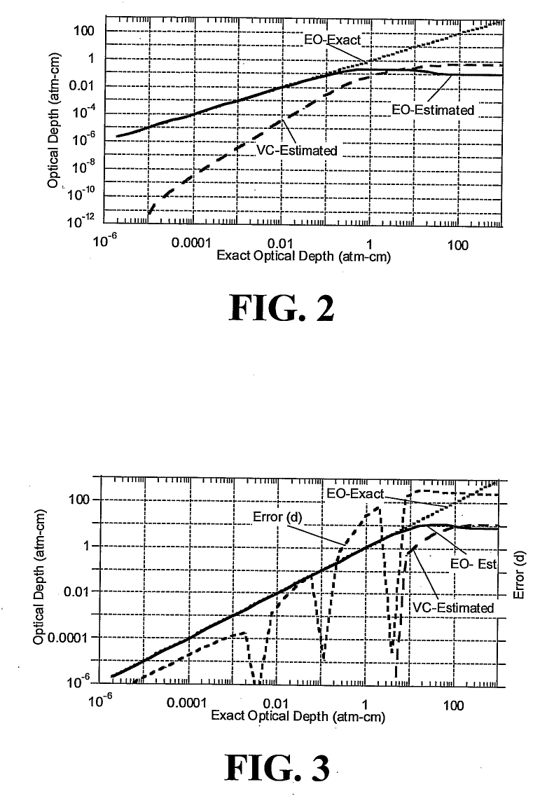

Referring to FIG. 2, it shows the estimated optical depths of both chemicals as the exact optical depth of EO is varied from 10⁻⁶ to 10³ atm-cm. The straight line represents the expected variation of the estimated optical depth of EO with its exact optical depth used to simulate the various responses. A perfect unmixing technique would produce estimates of EO that follow this line precisely through the entire range of this simulation and at the same time show zero quantities of VC. Note that at low optical depths, where the response is expected to be linear, the estimated depth of EO follows the linear line very well and only trace amounts of VC are estimated. However, as the exact depth of EO increases beyond 10⁻¹ atm-cm, the estimated optical depth of EO deviates significantly from the line that represents the exact optical depth. In addition, the method erroneously estimates significant amounts of VC, even at intermediate levels of EO. Thus, this may be construed as indicating a false positive detection of VC.

Other linear analysis techniques (e.g., orthogonal subspace projection (OSP), principal components analysis (PCA)) suffer from the same limitations as the least squares projection, although their implementations differ in their details. In fact, OSP and PCA can shown to be analogous to linear least squares projection, as discussed by J. J. Settle in “On the Relationship Between Spectral Unmixing and Subspace Projection,” and will not be considered as separate methods.

### Projection at Multiple Optical Depths

The errors in linear least squares projection method arise because, as the optical depth increases, the signature response vector for a given chemical deviates from its initial (low optical depth) trajectory, resulting from the exponential variation (equation. 1) in system response. Improvements can be expected if we include additional signature vectors for all the chemicals of the library, where each additional signature is calculated at a different optical depth for that chemical, thereby expanding the subspace spanned by the signature library. The optical depth for a given response vector can then be determined by least squares projection of the response vector onto each of the signatures as if they were independent chemicals.

FIG. 3 presents the results of this procedure for the two-chemical case used above. Here, three optical depths for both chemicals (Cᵢl=3.81×10⁻³, 1.22×10⁻¹, and 3.91 atm-cm) were used to generate a total of six chemical signatures for the six possible mixture pairs. The exact response vector of the sensor to EO was then simulated for a wide range of optical depths and projected onto the signatures using Equation (6) with the matrix M now containing all six of the signature vectors. The optical depth of each chemical was determined from the sum of the estimated optical depths for each of the six signatures multiplied by the optical depth used to create each signature. Although the present example shows that each chemical is described by three signatures, each at a different optical depth, more signatures may be included in the analysis to improve the prediction accuracy. In addition, for sensors that depend for detection on sampling the air rather than on absorption that depends also on the absorption path length, the signatures of each chemical will be defined by the concentration Cᵢ and not the optical depth Cᵢl.

As FIG. 3 shows, the method better predicts the optical depth of EO than the simple (single signature) analysis presented above, as demonstrated by the agreement between the curves representing the exact and estimated optical depths of EO for Cᵢl<10 atm-cm. Beyond that optical depth, the curve deviates substantially from linearity, thereby representing an error that is realized at high optical thicknesses. Additionally, significant amounts of VC are estimated in the same region thereby representing potential for false positive detection.

The results can be improved by including a wider variety of chemical signatures (i.e., a larger number of optical depths at which signatures are determined); however, at high optical depths, many signatures are needed to preclude the false identification of VC.

This method can also be expanded to analyze mixtures of two or more chemicals. For such mixture, a signature will be developed for each composition of chemicals and for the various possible combinations of concentrations of each of the mixture components. Clearly, for such an application the data-base may grow substantially. But it may be practical when the number of expected chemicals (or stimulants) is small or when the computing and data storage power is high.

### Curve Parameterization

Another method for unmixing the sensor response is to parameterize the NNR of each channel as a function of the optical depth of the target chemical(s). Then the optical depth of one or more chemicals can be estimated by “inverting” the parameterized curves to get optical depth as a function of NNR.

A simple form of the NNR for one channel and one chemical uses a single exponential term to parameterize the response:

$$r = {r}_{sat} ( 1 - {exp}^{- \frac{{m}_{lin}}{{r}_{sat}} Cl} ) , \qquad ( 7 )$$

where rₛₐₜ is the NNR at optical saturation (defined as the point where increasing the optical depth no longer affects the response) for the given chemical, and mₗᵢₙ is its slope at low concentrations as defined by:

$${m}_{lin} = \frac{d r}{d ( C𝓁 )} {\vert}_{( C𝓁 ) \to 0} . \qquad ( 8 )$$

Note that the terms rₛₐₜ and mₗᵢₙ are unique for each combination of chemical and channel and so for multiple channels, equation 7 must be written for each channel separately using the unique parameters for that channel. Thus equation 7 represents a set of equations.

Although it may not provide the best fit in a least-squares sense, this form is chosen so that the parameterized response in the linear region will be exact in the limit as optical depth goes to zero and the parameterized response at high concentrations will equal the saturated response of the given chemical. Other methods of defining the response curve (i.e., least squares fitting) can also be used.

Using nomenclature similar to Equation (4), Equation (7) can be written in the form:

$$1 - \frac{{r}_{j}}{{r}_{j , sat}} \approx {e}^{- {\sum }_{i}^{ } {a}_{ij} {x}_{i}} , \qquad ( 9 )$$

where aᵢⱼ is the quantity

$$\frac{{m}_{lin}}{{r}_{sat}}$$

for the i^{th} chemical and the j^{th} channel and r_{j,sat} is the response of channel j when all chemicals of interest are optically saturated. Thus, the parameterization is equivalent to solving the system of equations to provide solutions to xᵢ:

\tilde{r}≈Mx (10),

where \tilde{r} is a vector containing the quantities ln

$$( 1 - \frac{{r}_{j}}{{r}_{sat}} ) ,$$

with the logarithm taken term by term. Equation (10) can be solved using a suitable linear technique; again, we use linear least squares projection to find the optical depth of each chemical:

\hat{x}=(A′S⁻¹A)⁻¹A′S⁻¹\tilde{r} (11)

where A is a matrix containing the terms mₗᵢₙ/rₛₐₜ for each channel and each candidate chemical; A′ is the transpose of matrix A; S is the noise covariance matrix of the system and \hat{x} is a vector for the concentration of the chemicals included in the library, or the optical depth of chemical included in the library, or the magnitude of the stimulants included in the library. In some applications the matrix S can be omitted or replaced by the identity matrix. Also note that when using a sampling sensor such as the electronic nose, the optical depth term is replaced with the concentration Cᵢ.

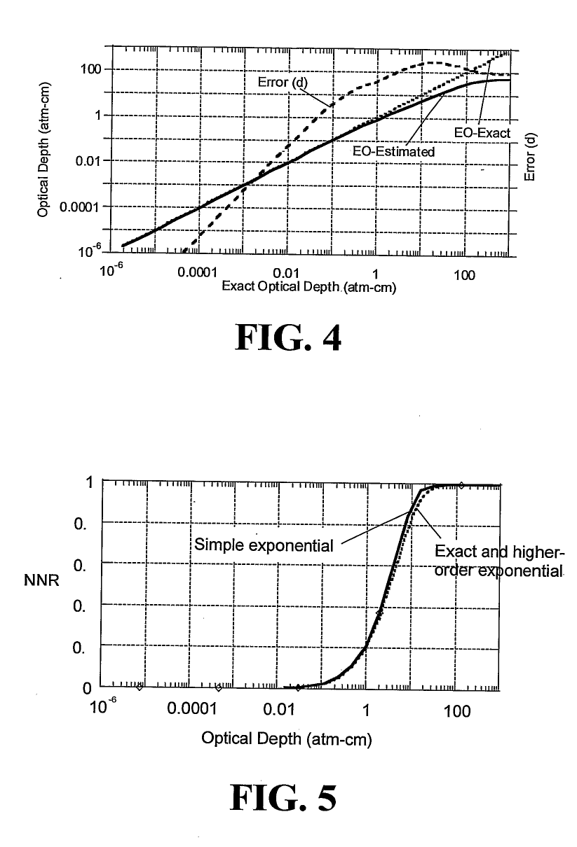

Referring to FIG. 4, it shows a comparison between the exact and estimated optical depths for EO using a one-chemical library. The response vector of EO was simulated at a wide range of optical depths and unmixed using Equation (11). Again, the agreement between the exact and estimated optical depths is excellent when the exact optical depth is below 1 atm-cm. However, as the exact optical depth increases, the difference between the exact and estimated depths increases, leading to significant error as represented by the Mahalanobis distance, d (EQN. 3), starting around an optical depth of 1.0 atm-cm. Interestingly, d falls off at high optical depths even though the difference between the exact and estimated optical depths of EO increases, a result of the fact that the response of the sensor is nearly saturated at both the exact and estimated concentrations, even though the optical depths themselves are not equal.

The parameterization in Equation (7) fails at high optical depths because it does not take into account the differing sensitivities of the channels to the fine structure of the absorptivity spectrum of each chemical. That is, at low optical depths, the response will be dominated by the strong absorption lines (i.e., where αᵢ(λ) is large). As the optical depth increases, however, the strong lines will saturate first, and the differential response due to further increases in optical depth will increasingly depend on weaker absorption lines.

This knowledge suggests that our estimate can be improved by including additional exponential terms in our approximation of the response curve. Specifically, it was found that good agreement can be obtained with the following form:

$$r = {r}_{sat} ( 1 - ( 1 - ɛ ) {exp}^{- \frac{{m}_{lin}}{{r}_{sat}} C𝓁} - ɛ {exp}^{- σ \frac{{m}_{lin}}{{r}_{sat}} C𝓁} ) , \qquad ( 12 )$$

where σ and ε are coefficients to be determined through the calibration process, σ>1 accounts for the effects of the higher exponentials in Equation (2) and 0≦ε≦1, and again are unique for each combination of chemical and channel. As with equation 7, equation 12 is a representative equation that describes the response of a single channel. For multiple channels, additional equations are required, each including the parameters that are unique to that channel. Also note that when using a sampling sensor such as the electronic nose, the optical depth term is replaced with concentration Cᵢ.

Using this form again guarantees that parameterized response will match both the linear (low optical depth) region and the saturated region. The coefficients σ and ε were calculated by minimizing the squared difference between the logarithms of the exact response and the parameterized response over a wide range of optical depths, i.e., minimizing:

f(ε,σ)=Σ ln²(r−\hat{r}) (13).

An iterative procedure was used where the optimal σ was chosen for a given ε, and then ε was adjusted (and σ recalculated) until f(ε,σ) was minimized (equation 13). FIG. 5 shows the exact NNR of one detector as a function of the optical depth of EO and the parameterized response curves using both the simple exponential of Equation (7) and higher-order approximation of Equation (12). Notice that the additional exponential improves the parameterization significantly, as evidenced by the close (nearly indistinguishable) agreement between the curves labeled exact and higher-order in the figure.

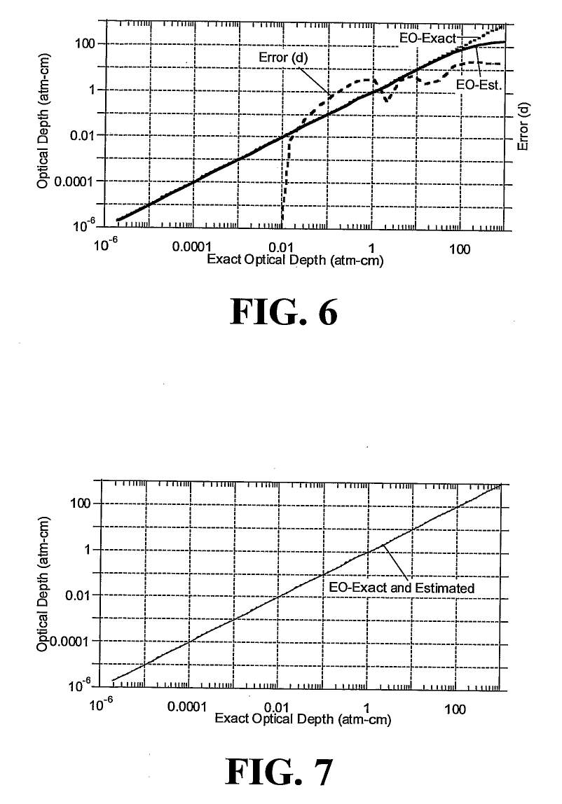

FIG. 6 shows a comparison between the exact and estimated optical depths for a single chemical using the higher-order approximation. The response vector was simulated for a wide range of optical depths of EO and unmixed by solving Equation (12) for each channel and averaging the results. Note that the agreement between exact and estimated optical depths is improved over the simple exponential parameterization (as seen in FIG. 4), with good agreement up to optical depths of about 10² atm-cm. The estimation error as represented by the Mahalanobis distance (equation 3) d is also reduced significantly.

Using the higher-order parameterization increases the complexity of the method, however, as there is no analytic solution for optical depth, Cl, in the transcendental equation expressed in equation (12). Instead, iterations (such as the Newton-Raphson technique) must be used. Additionally, when multiple species are used to calculate the signatures, the signatures become higher-dimensional surfaces and require additional terms, including exponentials with the products of the optical depths of multiple species and additional constants (e.g., terms of the form −ε₁₂ exp^{-a}^{₁₂}^{C}^{₁}^{C}^{₂}^{l} will show up when mixtures of two chemicals are considered). Although such approach has not been fully studied yet, this disclosure also includes the use of higher order exponents in Equation 12 either to improve the accuracy of the analysis of a single component or to analyze multi component mixtures.

### Non-Linear Iterative Solutions

A more accurate, but more computationally intensive method for determining the optical depths (or concentration when using a sampling sensor) of one or more chemicals uses non-linear iteration. A non-linear iteration can be used either by itself or to improve the results of one or more of the previous methods (which often give reasonable initial estimates). The method implemented here uses a localized linear projection to refine subsequent estimates of the optical depth (or concentration). Given an estimate of optical depth at iteration k, xₖ, the correction, δ, can be found by linearizing about the response vector at that estimate, \hat{r}ₖ, and solving the equation:

Mδ=r−\hat{r}ₖ (14),

where the linearized signatures contained in M are simply the elements of the Jacobian matrix

$$M = \frac{\partial \hat{r}}{\partial x} {\vert}_{{x}_{k}} , \qquad ( 15 )$$

and r and \hat{r} are the exact and estimated response vectors, respectively. Thus, we can estimate the correction, δ, to the optical depth by solving Equation (14) using any suitable linear technique (we use linear least squares projection). The optical depths (or concentration) are updated by xₖ₊₁=xₖ+δ and a new rₖ₊₁ is found. The process is iterated until δ reaches some specified, small value. With a noise-free signal, this method gives an exact answer to within the convergence limit on δ. FIG. 7 shows the result of unmixing the system response due to EO using a library of EO and VC. Note that the optical depth of EO matches the exact optical depth and the estimated optical depth of VC is zero.

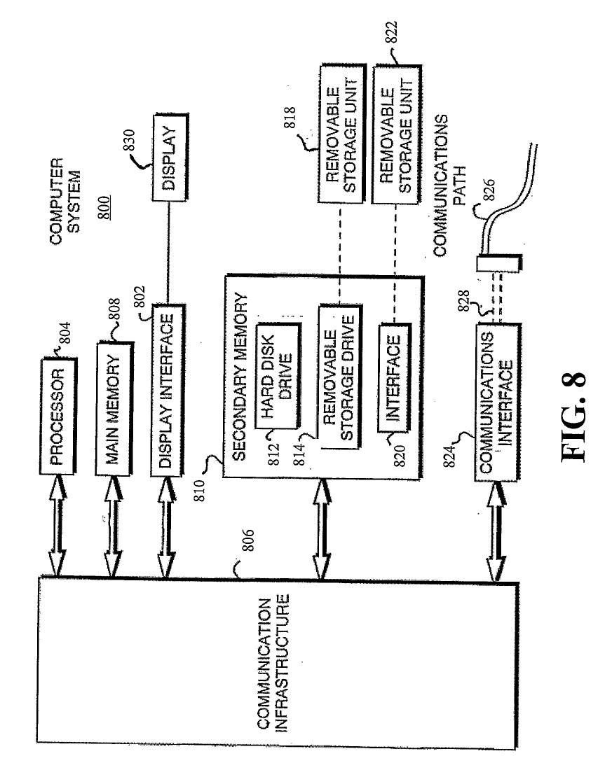

Turning to FIG. 8, FIG. 8 is a functional block diagram for a computer system 800 for implementation of an exemplary embodiment or portion of an embodiment of present invention. For example, a method of an embodiment of the present invention may be implemented using hardware, software or a combination thereof and may be implemented in one or more computer systems or other processing systems, such as personal digit assistants (PDAs), operated to analyze data from a cross-reactive, non-linear sensor. Such analysis may include using various mathematical and algorithmic techniques to achieve an estimate of the magnitudes, more accurately than with linear techniques, of one or more stimulants that are being detected and/or measured by a sensor or sensors of a chemical detection system that may be discussed herein and/or shown in FIGS. 1-7. The methods may analyze data produced by a plurality of cross-reactive channels that respond non-linearly to the magnitude of one or more stimulants, to differentiate between these stimulants, identify them, and determine their magnitudes,

In an example embodiment, an embodiment of the invention was implemented in software running on a general purpose computer 800 as illustrated in FIG. 8. Computer system 800 includes one or more processors, such as processor 804 Processor 804 is connected to a communication infrastructure 806 (e.g., a communications bus, cross-over bar, or network). The computer system 800 may include a display interface 802 that forwards graphics, text, and other data from the communication infrastructure 806 (or from a frame buffer not shown) for display on the display unit 830.

The computer system 800 also includes a main memory 808, preferably random access memory (RAM), and may also include a secondary memory 810. The secondary memory 810 may include, for example, a hard disk drive 812 and/or a removable storage drive 814, representing a floppy disk drive, a magnetic tape drive, an optical disk drive, a flash memory, etc. The removable storage drive 814 reads from and/or writes to a removable storage unit 818 in a well known manner. Removable storage unit 818, represents a floppy disk, magnetic tape, optical disk, etc. which is read by and written to by removable storage drive 814. As will be appreciated, the removable storage unit 818 includes a computer usable storage medium having stored therein computer software and/or data.

In alternative embodiments, secondary memory 810 may include other means for allowing computer programs or other instructions to be loaded into computer system 800. Such means may include, for example, a removable storage unit 822 and an interface 820. Examples of such removable storage units/interfaces include a program cartridge and cartridge interface (such as that found in video game devices), a removable memory chip (such as a ROM, PROM, EPROM or EEPROM) and associated socket, and other removable storage units 822 and interfaces 820 which allow software and data to be transferred from the removable storage unit 822 to computer system 800.

The computer system 800 may also include a communications interface 824. Communications interface 824 allows software and data to be transferred between computer system 800 and external devices. Examples of communications interface 824 may include a modem, a network interface (such as an Ethernet card), a communications port (e.g., serial or parallel, etc.), a PCMCIA slot and card, a modem, etc. Software and data transferred via communications interface 824 are in the form of signals 828 which may be electronic, electromagnetic, optical or other signals capable of being received by communications interface 824. Signals 828 are provided to communications interface 824 via a communications path (i.e., channel) 826. Channel 826 carries signals 828 and may be implemented using wire or cable, fiber optics, a phone line, a cellular phone link, an RF link, an infrared link, wireless link or connection and other communications channels.

In this document, the terms “computer program medium” and “computer usable medium” are used to generally refer to media or medium such as removable storage drive 814, a hard disk installed in hard disk drive 812, and signals 828. These computer program products are means for providing software to computer system 800. The computer program product may comprise a computer useable medium having computer program logic thereon. The invention includes such computer program products. The “computer program product” and “computer useable medium” may be any computer readable medium having computer logic thereon.

Computer programs (also called computer control logic or computer program logic) are stored in main memory 808 and/or secondary memory 810. Computer programs may also be received via communications interface 824. Such computer programs, when executed, enable computer system 800 to perform the features of the present invention as discussed herein. In particular, the computer programs, when executed, enable processor 804 to perform the functions of the present invention. Accordingly, such computer programs represent controllers of computer system 800.

In an embodiment where the invention is implemented using software, the software may be stored in a computer program product and loaded into computer system 800 using removable storage drive 814, hard drive 812 or communications interface 824. The control logic (software), when executed by the processor 804, causes the processor 804 to perform the functions of the invention as described herein.

In another embodiment, the invention is implemented primarily in hardware using, for example, hardware components such as application specific integrated circuits (ASICs). Implementation of the hardware state machine to perform the functions described herein will be apparent to persons skilled in the relevant art(s).

In yet another embodiment, the invention is implemented using a combination of both hardware and software.

In an example software embodiment of the invention, the methods described above were implemented in SPSS control language, but could be implemented in other programs such as, but not limited to, C++ programming language or other programs available to those skilled in the art.

The devices, methods and computer program product of various embodiments of the present invention discussed throughout may be practiced and implemented with the methods, systems and devices disclosed in the following U.S. patents, U.S. patent application Publications, PCT International Applications and references, and are hereby incorporated by reference herein in their entirety:
1. Holland, S. K. “Low-cost remote chemical sensing.” Dissertation, University of Virginia. 2004.
2. Settle, J. J., “On the relationship between spectral unmixing and subspace projection,” IEEE Trans. Geosci. Remote Sensing, 34, 1045-1046, 1996.
3. G. Laufer, “Passive Remote Sensors of Chemicals,” U.S. Pat. No. 6,853,452 B1, issued Feb. 8, 2005, and corresponding International Patent Application No. PCT/US00/04027, filed Feb. 18, 2000.
4. S. K. Holland, R. H. Kraus, J. M Childers and G. Laufer, “System and Method for Remote Sensing and/or Analyzing Properties of Targets and/or Chemical Species for Detection and Identification Thereof,” International Patent Application PCT/US2004/003801, filed Feb. 10, 2004, and corresponding U.S. application Ser. No. 10/544,421, filed Aug. 4, 2005.
5. International Application No. PCT/US2005/037030, filed Oct. 14, 2005, entitled “Remote Sensor and In-situ Sensor for Improved Detection of Chemicals in the Atmosphere and Related Method thereof.”
6. Alan Gelperin, Olfactory Sensor Identification and Method, U.S. Pat. No. 5,675,070, issued Feb. 9, 1996.
7. Brett J. Doleman, Erik J, Severin, Nathan S. Lewis, Method of Resolving Analytes in a Fluid, U.S. Pat. No. 6,571,603 B1, Issued Jun. 3, 2003.
8. Steven A, Sunshine, Computer Code for Portable Sensing, U.S. Pat. No. 6,606,566 B1 Issued Aug. 12, 2003
9. Steven A, Sunshine, Computer Code for Portable Sensing, U.S. Pat. No. 6,820,012 B2, Issued Nov. 16, 2004
10. Chang-Meng B. Hsiung, Bethsabez Munoz, Ajoy Kumar Roy, Michael Gregory Steinthal, Steven A. Sunshine, Michael Allan Vicic, Shou-Hua Zhang, Control for an Industrial Process Using One or More Multidimensional Variables, U.S. Pat. No. 6,853,920 B2, Issued Feb. 8, 2005.
11. Chang-Meng B. Hsiung, Jing Li, Beth Munoz, Ajoy K. Roy, Michael G. Steinthal, Steven A. Sunshine, Michael A. Vicic, Shou-Hua Zhang, Measuring and Analyzing Multi-Dimensional Sensory Information for Identification Purposes, U.S. Pat. No. 6,895,338 B2, Issued May 17, 2005.
12. Chang-Meng B. Hsiung, Bethshabez Munoz, Ajoy Kumar Roy, Michael Gregory Steinthal, Steven A. Sunshine, Michael Allen Vicic, Shou-Hua Zhang, Method for Monitoring Environmental Condition Using a mathematical Model, U.S. Pat. No. 6,917,845 B2, Issued Jul. 12, 2005.
13. David Klick, Kenneth A Marko, and Lajos Rimai, Optical Multi Channel Analysis With Rapid mass Storage Spectra: Application to CARS Measurements of Temperature Fluctuations, Applied Optics, Volume 23, Pages 1347-1352, May 1, 1984.
14. Zhen Hua Wang and David R. McKenzie, Use of Optical Multichannel Analyzer in Spectroscopy, Applied Optics, vol. 27, Pages 4960-4963, Dec. 1, 1988.
15. George Kychakoff, Robert D. Howe, Ronald K. Hanson, and James C. McDaniel, Quantitative Visualization of Combustion Species in a Plane, Applied Optics, Vol. 12, Pages 3225-3229, Sep. 15, 1982.
16. Gregory C. Lewin, Stephen K. Holland, and Gabriel Laufer, Algorithms for chemical detection with a Low-cost Multi-spectral Sensor, Paper 5778-54, Sensors, and Command, Control, Communications, and Intelligence (C₃1) Technologies for Homeland Security and Homeland Defense IV, SPIE Defense & Security Symposium, Orlando Fla., Mar. 28, 2005.

The invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims rather than by the foregoing description, and all changes, which come within the meaning and range of equivalency of the claims, are therefore intended to be embraced herein.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

We claim:

1. A method for analyzing signals from a plurality of cross reactive channels of a sensor of a system where the signals vary non-linearly with the quantities of stimulant that induce these signals, wherein the said method comprises:
obtaining signals from a plurality of channels from said sensor at a variety of known levels for each stimulant;
producing a net normalized result from each signal from the known levels;
creating a library of signatures that includes the net normalized result at each of the known levels of stimulant;
obtaining one or more signals from a plurality of channels from said sensor at unknown levels of stimulant;
producing a net normalized result from each signal from the unknown levels; and
unmixing the net normalized result from the unknown levels by projecting the sensor response onto the library of known signatures, with the various levels of each stimulant being treated as independent stimulants.

2. The method of claim 1, wherein said net normalized result is a signal of a given channel that is reference corrected by a predetermined mathematical formula defined as:
$$r = \frac{s ( 0 ) - s}{s ( 0 )} = \frac{\int [ ( ɛ {W}_{s} - {W}_{v} ) ( 1 - {e}^{- {\sum }_{i} {α}_{i} ( λ ) {C}_{i} 𝓁} ) ] {τ}_{f} ( λ ) d λ}{\int [ {ɛ}_{s} {W}_{s} ( λ ) ] {τ}_{f} ( λ ) d λ}$$
wherein:
r is the net normalized result;
s is the signal for a given channel;
s(0) is a reference signal for the given channel;
τ(λ) is the transmission by a radiation filter attached to said channel;
αᵢ(λ) is the absorptivity of chemical species i;
λ is the wavelength of the radiation transmitted by the filter attached to said channel;
Cᵢ is the concentration of chemical species i;
l is the path length of radiative absorption;
Wₛ and Wᵥ represent the directional spectral radiant emission from the heat source and the detected chemical, respectively, and are defined by the Planck function at their respective temperatures; and
εₛ is the spectral emissivity of the source.

3. The method of claim 1, wherein said net normalized result is a signal that is reference corrected by subtracting it from a known reference signal and dividing the net result by the reference signal.

4. The method of claim 1, wherein said unmixing by projecting finds the concentration of the chemicals or the magnitudes of the stimulants by a predetermined mathematical formula defined as:
$${r}_{j} \approx {\sum }_{i} {a}_{ij} {x}_{i}$$
wherein:
rⱼ is the net normalized result of channel j;
xᵢ is a convenient short hand for the concentration of chemical i, or the optical depth of chemical i, or the magnitude of the i^{th} stimulant; and
coefficients aᵢⱼ represent the contribution of the absorptivity of chemical i or the response created by the i^{th} stimulant to the net normalized result of channel j.

5. A method for analyzing signals from a plurality of cross reactive channels of a sensor of a system, where the signals vary non-linearly with the quantity of stimulants that induce these signals wherein the said method comprises:
obtaining signals from a plurality of channels from said sensor at a variety of known levels for each stimulant;
producing a net normalized result from each signal from the known levels;
creating a library of signatures by developing a parameterized equation that matches the net normalized result at each of the known levels of each stimulant in terms of the level of stimulant;
obtaining one or more signals from a plurality of channels from said sensor at unknown levels of stimulants;
producing a net normalized result from each signal from the unknown levels; and
unmixing the net normalized result from the unknown levels by comparing it to the library of parameterized signatures.

6. The method of claim 5, wherein the match is determined by a best match.

7. The method of claim 5, wherein the parameterized equation approximates the net normalized result at each of the known levels of each stimulant in terms of the level of stimulant.

8. The method of claim 5, wherein said net normalized result is a signal that is reference corrected by a predetermined mathematical formula defined as:
$$r = \frac{s ( 0 ) - s}{s ( 0 )} = \frac{\int [ ( ɛ {W}_{s} - {W}_{v} ) ( 1 - {e}^{- {\sum }_{i} {α}_{i} ( λ ) {C}_{i} 𝓁} ) ] {τ}_{f} ( λ ) d λ}{\int [ {ɛ}_{s} {W}_{s} ( λ ) ] {τ}_{f} ( λ ) d λ}$$
wherein:
r is the net normalized result;
s is the signal for a given channel;
s(0) is a reference signal for the given channel;
τ(λ) is the transmission by a radiation filter attached to said channel;
αᵢ(λ) is the absorptivity of chemical species i;
λ is the wavelength of the radiation transmitted by the filter attached to said channel;
Cᵢ is the concentration of chemical species i;
l is the path length;
Wₛ and Wᵥ represent the directional spectral radiant emission from the heat source and gas, respectively, and are defined by the Planck function at their respective temperatures; and
εₛ is the spectral emissivity of the source.

9. The method of claim 5, wherein said net normalized result is a signal that is reference corrected by subtracting a known reference signal and dividing the net result by the measured signal.

10. The method of claim 5, wherein said parameterized equation of said net normalized results is defined as:
$$r = {r}_{sat} ( 1 - {exp}^{- \frac{{m}_{lin}}{{r}_{sat}} C𝓁 } )$$
wherein:
r is the net normalized result,
rₛₐₜ is the net normalized result at saturation defined as the point where increasing the optical depth or the magnitude of the stimulant no longer affects the response for the given chemical or stimulant,
mₗᵢₙ is its slope at low concentrations or low magnitude of the stimulant, and
Cᵢl is the optical depth of the i^{th} chemical or the response created by the i^{th} stimulant.

11. The method of claim 5, wherein said parameterized equation of said net normalized results is defined as:
$$r = {r}_{sat} ( 1 - ( 1 - ɛ ) {exp}^{- \frac{{m}_{lin}}{{r}_{sat}} C𝓁} - ɛ {exp}^{- σ \frac{{m}_{lin}}{{r}_{sat}} C𝓁} )$$
wherein:
r is the net normalized result;
rₛₐₜ is the net normalized result at optical saturation defined as the point where increasing the optical depth no longer affects the response for the given chemical;
mₗᵢₙ is its slope at low concentrations or low magnitude of stimulant;
Cᵢl is the optical depth of i^{th} chemical or the response created by the i^{th} stimulant;
σ>1 is a parameter that accounts for the effects of the higher exponentials; and
0≦ε≦1.

12. The method of any one claims 5, 10 and 11, wherein said unmixing is performed using a least-squares projection defined by the formula:
\hat{x}=(A′S⁻¹A)⁻¹A′S⁻¹\tilde{r}
wherein:
\tilde{r} is a vector of the terms ln(1−rⱼ/rₛₐₜ) of the net normalized result, where j refers to each channel;
A is a matrix containing the terms mₗᵢₙ/rₛₐₜ for each channel and each candidate chemical;
A′ is the transpose of matrix A;
S is the noise covariance matrix of the system; and
\hat{x} is a vector for the concentration of the chemicals included in the library, or the optical depth of chemical included in the library, or the magnitude of the stimulants included in the library.

13. The method of claim 12, wherein the noise covariance matrix of the system is omitted and replaced with an identity matrix.

14. The method of any one of claims 12 and 13, wherein a stimulant is identified by finding the distances between the vectors of the predicted net normalized results for each stimulant as determined from the values of \hat{x} and the corresponding vectors of the net normalized result as obtained by the sensor and selecting among those distances the shortest distance.

15. The method of claim 13, wherein the distance between the vectors is the Mahalanobis distance, which is
dₛₜᵢₘᵤₗₐₙₜ²=(r−\hat{r})′S⁻¹(r−\hat{r})
wherein:
r is the vector of net normalized responses as obtained by the sensor;
\hat{r} is the vector of the predicted net normalized responses as obtained by using the calculated values of \hat{x}; and
S is the noise covariance matrix of the system.

16. The method of claim 15, wherein the noise covariance matrix of the system is omitted and replaced with an identity matrix.

17. A method for analyzing signals from a plurality of cross reactive channels of a sensor of a system where the signals vary non-linearly with the magnitude of stimulants that induce these signals, wherein the said method comprises:
obtaining signals from a plurality of channels from said sensor;
producing a net normalized result from each signal;
estimating initially the magnitude or magnitudes of stimulant(s);
predicting a net normalized result from a model of the physics of the system by using said estimated magnitude or magnitudes of stimulant(s);
determining the difference between the actual net normalized result and the predicted net normalized result;
using said difference to solve for a correction to the estimated magnitude(s);
updating the magnitude or magnitudes of stimulant(s); and
repeating the prediction, determination of the difference, determination of the correction, and updating the magnitude(s).

18. The method of claim 17, wherein said updating of the stimulants is determined by estimating the correction, δ, to the magnitude by using a predetermined mathematical formula defined as:
Aδ=r−\hat{r}ₖ
wherein:
r is a vector containing the actual net normalized result for each channel,
\hat{r}ₖ is a vector containing the predicted net normalized result,
A is a matrix containing the theoretical, linearized response of the system at the predicted net normalized results, \hat{r}ₖ, and
wherein the magnitudes of the stimulants are updated by predetermined mathematical formula defined as:
xₖ₊₁=xₖ+δ
wherein xₖ is the current estimate of the magnitude of the stimulant at iteration k, and xₖ₊₁ is the new estimate.

19. The method of claim 18, wherein said solving for a correction is determined mathematically by using any suitable linear techniques.

20. The method of any one of claims 1, 5, and 17, wherein said sensor comprises at least one of a remote sensor and/or in-situ sensor.

21. The method of claim 20, wherein said at least one remote sensor comprises an optical sensor.

22. The method of claim 21, wherein said optical sensor comprises at least one of TOTALLY OPTICAL VAPOR ANALYZER (TOVA) type sensor, a differential radiometer absorption type sensor, a Fourier transform type spectrometer or radiometer, a tunable etalon type sensor, a grating based spectrometer type sensor, or a lidar type sensor, a differential absorption lidar (DIAL) type sensor, or any combination thereof.

23. The method of claim 20, wherein said at least one in-situ sensor comprises at least one of the following types of sensors: surface acoustic wave (SAW), micro-cantilever (MC), ELECTRONIC NOSE (EN) type sensor, chemi-resitor type sensor, gas chromatograph type sensor, interferometric type waveguide sensor, chemical paper type sensor, TOTALLY OPTICAL VAPOR ANALYZER (TOVA) type sensor, a differential absorption type sensor, a Fourier transform type spectrometer or radiometer, a tunable etalon type sensor, a grating based spectrometer type sensor, a lidar type sensor, a differential absorption lidar (DIAL) type sensor, or Ion Mobility Spectrometer (IMS), or any combination thereof.

24. A system for analyzing signals from a plurality of cross reactive channels of a sensor of the system where the signals vary non-linearly with the quantities of stimulant that induce these signals, wherein the said system comprises at least one data processor adapted to:
obtain signals from a plurality of channels from said sensor at a variety of known levels for each stimulant;
produce a net normalized result from each signal from the known levels;
create a library of signatures that includes the net normalized result at each of the known levels of stimulant;
obtain one or more signals from a plurality of channels from said sensor at unknown levels of stimulant;
produce a net normalized result from each signal from the unknown levels; and
unmix the net normalized result from the unknown levels by projecting the sensor response onto the library of known signatures, with the various levels of each stimulant being treated as independent stimulants.

25. The system of claim 24, wherein said net normalized result is a signal of a given channel that is reference corrected by a predetermined mathematical formula defined as:
$$r = \frac{s ( 0 ) - s}{s ( 0 )} = \frac{\int [ ( ɛ {W}_{s} - {W}_{v} ) ( 1 - {e}^{- {\sum }_{i} {α}_{i} ( λ ) {C}_{i} 𝓁} ) ] {τ}_{f} ( λ ) d λ}{\int [ {ɛ}_{s} {W}_{s} ( λ ) ] {τ}_{f} ( λ ) d λ}$$
wherein:
r is the net normalized result;
s is the signal for a given channel;
s(0) is a reference signal for the given channel;
τ(λ) is the transmission by a radiation filter attached to said channel;
αᵢ(λ) is the absorptivity of chemical species i;
λ is the wavelength of the radiation transmitted by the filter attached to said channel;
Cᵢ is the concentration of chemical species i;
l is the path length of radiative absorption;
Wₛ and Wᵥ represent the directional spectral radiant emission from the heat source and the detected chemical, respectively, and are defined by the Planck function at their respective temperatures; and
εₛ is the spectral emissivity of the source.

26. The system of claim 24, wherein said net normalized result is a signal that is reference corrected by subtracting it from a known reference signal and dividing the net result by the reference signal.

27. The system of claim 24, wherein said unmixing by projecting finds the concentration of the chemicals or the magnitudes of the stimulants by a predetermined mathematical formula defined as:
$${r}_{j} \approx {\sum }_{i} {a}_{ij} {x}_{i}$$
wherein:
rⱼ is the net normalized result of channel j;
xᵢ is a convenient short hand for the concentration of chemical i, or the optical depth of chemical i, or the magnitude of the i^{th} stimulant; and
coefficients aᵢⱼ represent the contribution of the absorptivity of chemical i or the response created by the i^{th} stimulant to the net normalized result of channel j.

28. A system for analyzing signals from a plurality of cross reactive channels of a sensor of the system, where the signals vary non-linearly with the quantity of stimulants that induce these signals wherein the said system comprises at least one data processor adapted to:
obtain signals from a plurality of channels from said sensor at a variety of known levels for each stimulant;
produce a net normalized result from each signal from the known levels;
create a library of signatures by developing a parameterized equation that matches the net normalized result at each of the known levels of each stimulant in terms of the level of stimulant;
obtain one or more signals from a plurality of channels from said sensor at unknown levels of stimulants;
produce a net normalized result from each signal from the unknown levels; and
unmix the net normalized result from the unknown levels by comparing it to the library of parameterized signatures.

29. The system of claim 28, wherein the match is determined by a best match.

30. The system of claim 28, wherein the parameterized equation approximates the net normalized result at each of the known levels of each stimulant in terms of the level of stimulant.

31. The system of claim 28, wherein said net normalized result is a signal that is reference corrected by a predetermined mathematical formula defined as:
$$r = \frac{s ( 0 ) - s}{s ( 0 )} = \frac{\int [ ( ɛ {W}_{s} - {W}_{v} ) ( 1 - {e}^{- {\sum }_{i} {α}_{i} ( λ ) {C}_{i} 𝓁} ) ] {τ}_{f} ( λ ) d λ}{\int [ {ɛ}_{s} {W}_{s} ( λ ) ] {τ}_{f} ( λ ) d λ}$$
wherein:
r is the net normalized result;
s is the signal for a given channel;
s(0) is a reference signal for the given channel;
τ(λ) is the transmission by a radiation filter attached to said channel;
αᵢ(λ) is the absorptivity of chemical species i;
λ is the wavelength of the radiation transmitted by the filter attached to said channel;
Cᵢ is the concentration of chemical species i;
l is the path length;
Wₛ and Wᵥ represent the directional spectral radiant emission from the heat source and gas, respectively, and are defined by the Planck function at their respective temperatures; and
εₛ is the spectral emissivity of the source.

32. The system of claim 28, wherein said net normalized result is a signal that is reference corrected by subtracting a known reference signal and dividing the net result by the measured signal.

33. The system of claim 28, wherein said parameterized equation of said net normalized results is defined as:
$$r = {r}_{sat} ( 1 - {exp}^{- \frac{{m}_{lin}}{{r}_{sat}} C𝓁 } )$$
wherein:
r is the net normalized result,
rₛₐₜ is the net normalized result at saturation defined as the point where increasing the optical depth or the magnitude of the stimulant no longer affects the response for the given chemical or stimulant,
mₗᵢₙ is its slope at low concentrations or low magnitude of the stimulant, and
Cᵢl is the optical depth of the i^{th} chemical or the response created by the i^{th} stimulant.

34. The system of claim 28, wherein said parameterized equation of said net normalized results is defined as:
$$r = {r}_{sat} ( 1 - ( 1 - ɛ ) {exp}^{- \frac{{m}_{lin}}{{r}_{sat}} C𝓁} - ɛ {exp}^{- σ \frac{{m}_{lin}}{{r}_{sat}} C𝓁} )$$
wherein:
r is the net normalized result;
rₛₐₜ is the net normalized result at optical saturation defined as the point where increasing the optical depth no longer affects the response for the given chemical;
mₗᵢₙ is its slope at low concentrations or low magnitude of stimulant;
Cᵢl is the optical depth of i^{th} chemical or the response created by the i^{th} stimulant;
σ>1 is a parameter that accounts for the effects of the higher exponentials; and
0≦ε≦1.

35. The system of any one claims 28, 33 and 34, wherein said unmixing is performed using a least-squares projection defined by the formula:
\hat{x}=(A′S⁻¹A)⁻¹A′S⁻¹\tilde{r}
wherein:
\tilde{r} is a vector of the terms ln(1−rⱼ/rₛₐₜ) of the net normalized result, where j refers to each channel;
A is a matrix containing the terms mₗᵢₙ/rₛₐₜ for each channel and each candidate chemical;
A′ is the transpose of matrix A;
S is the noise covariance matrix of the system; and
\hat{x} is a vector for the concentration of the chemicals included in the library, or the optical depth of chemical included in the library, or the magnitude of the stimulants included in the library.

36. The system of claim 35, wherein the noise covariance matrix of the system is omitted and replaced with an identity matrix.

37. The system of any one of claims 35 and 36, wherein a stimulant is identified by finding the distances between the vectors of the predicted net normalized results for each stimulant as determined from the values of \hat{x} and the corresponding vectors of the net normalized result as obtained by the sensor and selecting among those distances the shortest distance.

38. The system of claim 36, wherein the distance between the vectors is the Mahalanobis distance, which is
dₛₜᵢₘᵤₗₐₙₜ²=(r−\hat{r})′S⁻¹(r−\hat{r})
wherein:
r is the vector of net normalized responses as obtained by the sensor;
\hat{r} is the vector of the predicted net normalized responses as obtained by using the calculated values of \hat{x}; and
S is the noise covariance matrix of the system.

39. The system of claim 38, wherein the noise covariance matrix of the system is omitted and replaced with an identity matrix.

40. A system for analyzing signals from a plurality of cross reactive channels of a sensor of the system where the signals vary non-linearly with the magnitude of stimulants that induce these signals, wherein the said system comprises at least one data processor adapted to:
obtain signals from a plurality of channels from said sensor;
produce a net normalized result from each signal;
estimate initially the magnitude or magnitudes of stimulant(s);
predict a net normalized result from a model of the physics of the system by using said estimated magnitude or magnitudes of stimulant(s);
determine the difference between the actual net normalized result and the predicted net normalized result;
use said difference to solve for a correction to the estimated magnitude(s);
update the magnitude or magnitudes of stimulant(s); and
repeat the prediction, determination of the difference, determination of the correction, and updating the magnitude(s).

41. The system of claim 40, wherein said updating of the stimulants is determined by estimating the correction, δ, to the magnitude by using a predetermined mathematical formula defined as:
Aδ=r−\hat{r}ₖ
wherein:
r is a vector containing the actual net normalized result for each channel,
\hat{r}ₖ is a vector containing the predicted net normalized result,
A is a matrix containing the theoretical, linearized response of the system at the predicted net normalized results, \hat{r}ₖ, and
wherein the magnitudes of the stimulants are updated by predetermined mathematical formula defined as:
xₖ₊₁=xₖ+δ
wherein xₖ is the current estimate of the magnitude of the stimulant at iteration k, and xₖ₊₁ is the new estimate.

42. The system of claim 41, wherein said solving for a correction is determined mathematically by using any suitable linear techniques.

43. The system of any one of claims 24, 28, and 40, wherein said sensor comprises at least one of a remote sensor and/or in-situ sensor.

44. The system of claim 43, wherein said at least one remote sensor comprises an optical sensor.

45. The system of claim 44, wherein said optical sensor comprises at least one of TOTALLY OPTICAL VAPOR ANALYZER (TOVA) type sensor, a differential radiometer absorption type sensor, a Fourier transform type spectrometer or radiometer, a tunable etalon type sensor, a grating based spectrometer type sensor, or a lidar type sensor, a differential absorption lidar (DIAL) type sensor, or any combination thereof.

46. The system of claim 43, wherein said at least one in-situ sensor comprises at least one of the following types of sensors: surface acoustic wave (SAW), micro-cantilever (MC), ELECTRONIC NOSE (EN) type sensor, chemi-resitor type sensor, gas chromatograph type sensor, interferometric type waveguide sensor, chemical paper type sensor, TOTALLY OPTICAL VAPOR ANALYZER (TOVA) type sensor, a differential absorption type sensor, a Fourier transform type spectrometer or radiometer, a tunable etalon type sensor, a grating based spectrometer type sensor, a lidar type sensor, a differential absorption lidar (DIAL) type sensor, or Ion Mobility Spectrometer (IMS), or any combination thereof.

47. A computer program product comprising a computer useable medium having computer program logic for enabling one processor in a computer system to analyze signals from a plurality of cross reactive channels of a sensor of a system where the signals vary non-linearly with the quantities of stimulant that induce these signals, said computer program logic comprises:
obtaining signals from a plurality of channels from said sensor at a variety of known levels for each stimulant;
producing a net normalized result from each signal from the known levels;
creating a library of signatures that includes the net normalized result at each of the known levels of stimulant;
obtaining one or more signals from a plurality of channels from said sensor at unknown levels of stimulant;
producing a net normalized result from each signal from the unknown levels; and
unmixing the net normalized result from the unknown levels by projecting the sensor response onto the library of known signatures, with the various levels of each stimulant being treated as independent stimulants.

48. A computer program product comprising a computer useable medium having computer program logic for enabling one processor in a computer system to analyze signals from a plurality of cross reactive channels of a sensor of a system, where the signals vary non-linearly with the quantity of stimulants that induce these signals, said computer program logic comprises:
obtaining signals from a plurality of channels from said sensor at a variety of known levels for each stimulant;
producing a net normalized result from each signal from the known levels;
creating a library of signatures by developing a parameterized equation that matches the net normalized result at each of the known levels of each stimulant in terms of the level of stimulant;
obtaining one or more signals from a plurality of channels from said sensor at unknown levels of stimulants;
producing a net normalized result from each signal from the unknown levels; and
unmixing the net normalized result from the unknown levels by comparing it to the library of parameterized signatures.

49. A computer program product comprising a computer useable medium having computer program logic for enabling one processor in a computer system to analyze signals from a plurality of cross reactive channels of a sensor of a system where the signals vary non-linearly with the magnitude of stimulants that induce these signals, said computer program logic comprises:
obtaining signals from a plurality of channels from said sensor;
producing a net normalized result from each signal;
estimating initially the magnitude or magnitudes of stimulant(s);
predicting a net normalized result from a model of the physics of the system by using said estimated magnitude or magnitudes of stimulant(s);
determining the difference between the actual net normalized result and the predicted net normalized result;
using said difference to solve for a correction to the estimated magnitude(s);
updating the magnitude or magnitudes of stimulant(s); and
repeating the prediction, determination of the difference, determination of the correction, and updating the magnitude(s).
